(19) United States
(12) Patent Application Publication
(10) Pub. No.: US 2026/0313311 A1
(43) Pub. Date: Oct. 8, 2026

(54) SYSTEM AND METHOD FOR DYNAMIC SOUND REINFORCEMENT

(71) Applicant: Shure Acquisition Holdings, Inc., Niles, IL (US)

(72) Inventors: Bijal Joshi, Elk Grove Village, IL (US); Douglas Daube, Des Plaines, IL (US)

(21) Appl. No.: 19/641,383

(22) Filed: Apr. 7, 2026

Related U.S. Application Data
(60) Provisional application No. 63/784,623, filed on Apr. 7, 2025.

(51) Int. Cl. H04S 7/00; H04R 5/02

(52) U.S. Cl. CPC H04S 7/303; H04R 5/02

(57) ABSTRACT

Systems and methods are described herein to provide dynamic sound reinforcement of an audio source for one or more listeners in an environment comprising a microphone for converting sounds produced by the audio source into audio signals, a first loudspeaker for playing the audio signals, and one or more processors for calculating a first distance between a first speaker location associated with the first loudspeaker and a first audio source location associated with the audio source; determining, based on the first distance, a first value for a sound reinforcement setting of the first loudspeaker; calculating a second distance between the first speaker location and a second audio source location associated with the audio source; determining, based on the second distance, a second value for the sound reinforcement setting of the first loudspeaker; and adjusting the sound reinforcement setting of the first loudspeaker from the first value to the second value.

### CROSS-REFERENCE TO RELATED APPLICATIONS

This application claims priority to U.S. Provisional Application Ser. No. 63/784,623, filed Apr. 7, 2025, the entire contents of which are incorporated herein by reference.

### TECHNICAL FIELD

This disclosure generally relates to an audio system located in a conference room, board room, or other environment, and more specifically, to systems and methods for providing dynamic sound reinforcement of captured audio based on talker position within the environment.

### BACKGROUND

Audio environments, such as, e.g., conference rooms, boardrooms, and other meeting rooms; video conferencing settings; classrooms, lecture halls, auditoriums, fitness rooms, and other presentation spaces; sports complexes, concert halls, arenas, theaters, and other performance venues; and the like, can involve the use of one or more microphones for capturing sounds from various audio sources and converting the sounds into audio signals. The audio sources may include performers, instructors, and other human speakers (or “talkers”), as well as musical instruments, and other non-human sound producers. The captured sounds may include speech, singing, and other vocal sounds, as well as music and other non-voice sounds. The captured audio signals may be disseminated to a local audience in the environment through audio output devices (e.g., loudspeakers) to provide sound reinforcement of the captured audio, and/or to persons located at one or more remote locations, for example, in connection with a telecast, webcast, conference call, online or televised performance, etc. The audio environment may include one or more additional loudspeakers for playing out loud audio signals received, via communication hardware, from the remote participants, or human speakers that are not located in the same room (also referred to as “far end audio”). These and other components of a given audio environment may be included in one or more audio devices (e.g., a conferencing device, microphone array, etc.) and/or operate as part of an audio system.

In general, microphones, or audio capturing devices, are available in a variety of sizes, form factors, mounting options, and wiring options to suit the needs of particular environments and/or audio events. The types of devices, their operational characteristics (e.g., lobe direction, gain, etc.), and their placement in a particular audio environment may depend on a number of factors, including, for example, the locations of the audio sources, locations of listeners, physical space requirements, aesthetics, room layout, and/or other considerations. For example, in some environments, a microphone may be placed on a table or lectern to be near the audio sources and/or listeners. In other environments, a microphone may be mounted overhead or on a wall to capture the sound from, or project sound towards, the entire room, for example. In some cases, one or more microphones may be handheld and/or wireless devices that are carried by, or attached to, the audio source (also referred to as a “talker”) in order to capture sound produced by the audio source as they move about the environment during the audio event.

Some audio systems use one or more loudspeakers to provide sound reinforcement during a live event, to ensure that all listeners can hear an audio source equally well, even if they are located far from the audio source. Typically, sound engineers, consultants, and/or installers are employed to ensure optimal sound reinforcement for a given environment, based on, for example, size and type of environment (e.g., large or small venue, fixed seating or variable, etc.), relative locations of the microphone(s) and loudspeaker(s), relative locations of the listeners or audience, acoustic characteristics of the environment (e.g., presence of external noise and/or internal noise, hard surfaces versus soft surfaces, etc.), type of presenter (e.g., stationary or mobile, music or speech output, etc.), and/or type of audio event (e.g., performance or lecture, etc.). However, for some venues, such specialized configurations may be prohibitively costly (e.g., due to equipment cost, installation cost, etc.), impractical (e.g., due to highly variable room arrangements, roaming audio sources, etc.), and/or unavailable (e.g., due to inability to accommodate permanent fixtures, inability to move or reconfigure loudspeakers, etc.), while others may not be aware of the need for, or benefits of, providing sound reinforcement during a live event.

Accordingly, there is still a need for an audio system that provides optimal sound reinforcement of audio signals produced by one or more microphones during a live audio event, for any type of environment, with minimal setup time, cost, and manual effort, and automatic maintenance as venue, talker, listener, and/or audio equipment configurations change.

### SUMMARY

The techniques of this disclosure provide systems and methods designed to, among other things: (1) provide optimal sound reinforcement of an audio source for one or more listeners in an environment based on the audio source location; (2) configure one or more settings of each sound reinforcement loudspeaker located in the environment based on a distance between the audio source and the corresponding device; and (3) dynamically adjust the sound reinforcement of audio signals playing on loudspeakers as the audio source moves to a new location in the environment.

One exemplary embodiment includes a method of providing dynamic sound reinforcement of an audio source for one or more listeners in an environment using one or more processors in communication with at least one microphone and a first loudspeaker, the microphone configured to convert sounds produced by the audio source into audio signals, and the first loudspeaker configured to play the audio signals, the method comprising, using any of the one or more processors: calculating a first distance between a first speaker location associated with the first loudspeaker and a first audio source location associated with the audio source; determining, based on the first distance, a first value for a sound reinforcement setting of the first loudspeaker; calculating a second distance between the first speaker location and a second audio source location associated with the audio source, the second audio source location different from the first audio source location; determining, based on the second distance, a second value for the sound reinforcement setting of the first loudspeaker; and adjusting the sound reinforcement setting of the first loudspeaker from the first value to the second value.

Another exemplary embodiment includes an audio system located in an environment, the audio system comprising: at least one microphone configured to: capture sounds produced by an audio source located in the environment, and convert the sounds to audio signals; a first loudspeaker configured provide sound reinforcement of the audio source for one or more listeners in the environment by playing the audio signals, the first loudspeaker positioned at a first speaker location; and one or more processors in communication with the at least one microphone and the first loudspeaker, any of the one or more processors configured to: calculate a first distance between the first speaker location and a first audio source location associated with the audio source; determine, based on the first distance, a first value for a sound reinforcement setting of the first loudspeaker; calculate a second distance between the first speaker location and a second audio source location associated with the audio source, the second audio source location different from the first audio source location; determine, based on the second distance, a second value for the sound reinforcement setting of the first loudspeaker; and adjust the sound reinforcement setting of the first loudspeaker from the first value to the second value.

Another exemplary embodiment includes a non-transitory computer-readable storage medium comprising instructions that, when executed by one or more processors, cause any of the one or more processors to perform: calculate a first distance between a first speaker location associated with a first loudspeaker and a first audio source location associated with an audio source; determine, based on the first distance, a first value for a sound reinforcement setting of the first loudspeaker; calculate a second distance between the first speaker location and a second audio source location associated with the audio source, the second audio source location different from the first audio source location; determine, based on the second distance, a second value for the sound reinforcement setting of the first loudspeaker; and adjust the sound reinforcement setting of the first loudspeaker from the first value to the second value.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a top view of an exemplary audio environment having a plurality of sound reinforcement loudspeakers and an audio source traveling through the environment, in accordance with one or more embodiments.

FIG. 2 is a block diagram illustrating a top view of another exemplary audio environment having a plurality of sound reinforcement loudspeakers and an audio source traveling through the environment, in accordance with one or more embodiments.

FIG. 3 is a block diagram illustrating an exemplary audio system, in accordance with one or more embodiments.

FIG. 4 is a flowchart illustrating an exemplary process for providing dynamic sound reinforcement of an audio source for one or more listeners in an environment, in accordance with one or more embodiments.

### DETAILED DESCRIPTION

Audio systems that provide sound reinforcement during a live performance, or other event, enable every audience member in the event space to hear the presenter, performer, or other person producing audio, no matter how far the listener is located from the audio source. Typically, such audio systems (or “sound reinforcement systems”) include at least one microphone located at the podium, stage, or other presentation area, as well as a plurality of loudspeakers (or “sound reinforcement speakers”) located throughout the event space, or at least in the areas where listeners are expected to be located. Voice and other audio captured by the microphone(s) are played out loud, or amplified, by the sound reinforcement speakers, so that listeners located at great distances from the audio source can hear the audio as if they were nearby. For example, some existing sound reinforcement systems are used only in meeting spaces, conference rooms, auditoriums, and other venues or event spaces where listeners are more than 25 feet (or 7.5 meters) away from the audio source(s).

In general, the exact number and placement of loudspeakers, and their respective amplification levels, can vary depending on the event space, including, for example, the type, size, and shape of the venue, expected size and location of the audience, placement of microphone(s), acoustic characteristics of the venue, and other factors. Larger and/or fixed venues (like arenas, concert halls, auditoriums, etc.) often use professional installers or sound engineers to optimally configure their space for high quality sound reinforcement, which typically includes permanent installation of appropriately-located loudspeakers based on known and/or fixed locations of audience members and audio sources (e.g., talkers, presenters, performers, etc.). Other, smaller venues, on the other hand (like classrooms, conference rooms, school gyms, fitness places, etc.) often have limited or no sound reinforcement due, at least in part, to the highly variable layout of the venue (e.g., reconfigurable chairs, tables, podiums, and other furniture, multi-purpose nature of the space, etc.) and thus, changing locations of talkers and listeners. In either case, sound reinforcement capabilities are constrained by an inability to adapt to changes in the configuration of the event space and/or the audio source location (e.g., due to a talker moving about the space), thus limiting the usability of the audio system and resulting in poor audio quality and user experience.

Systems and methods are provided herein for delivering dynamic sound reinforcement of audio produced by an audio source moving about an event space during a live event. Specifically, each sound reinforcement loudspeaker in the event space may be configured to provide a sound reinforcement effect that is tailored to the needs of nearby listeners based on a current or real-time position of the audio source, relative to that loudspeaker. For example, if the audio source moves closer to a first loudspeaker and further from a second loudspeaker, the listeners located near the first loudspeaker may require less sound reinforcement, while the listeners located near the second loudspeaker may require additional sound reinforcement in order to hear the audio source clearly. Accordingly, techniques described herein include dynamically adjusting a sound reinforcement setting (e.g., acoustic gain) of each loudspeaker based on a current or real-time distance between the loudspeaker location and the audio source location. As a result, all listeners of the live event are be able to hear the audio source as if they were located nearby, even as the audio source changes locations within the event space.

In embodiments, the event space, or environment, comprises a plurality of audio devices that are part of a larger audio system used to facilitate a live audio event. In some cases, the audio system may be configured to operate as an ecosystem comprised of the plurality of audio devices and a computing device that is in communication with each of the audio devices, for example, using a common communication protocol. The audio devices may include at least one microphone for capturing sounds produced by one or more audio sources and converting the sounds to audio signals, one or more loudspeakers for providing dynamic sound reinforcement of the audio signals output by the at least one microphone, and/or one or more sensors for detecting a live or real-time location of the audio source(s). In various embodiments, the computing device comprises at least one processor configured to (e.g., using software for implementing one or more processes described herein) provide dynamic sound reinforcement of audio signals generated by the at least one microphone and playing on the one or more loudspeakers, by adjusting a sound reinforcement setting of each loudspeaker(s) based on a real-time location of the audio source.

As used herein, the terms “lobe” and “microphone lobe” refer to a beamformed audio beam generated by a given microphone array (or array microphone) to pick up sounds at a select location, such as the location towards which the lobe is directed. While the techniques disclosed herein are described with reference to microphone lobes generated by array microphones, the same or similar techniques may be utilized with other forms or types of microphone coverage (e.g., a cardioid pattern, etc.) and/or with microphones that are not array microphones (e.g., a handheld microphone, boundary microphone, lavalier microphones, etc.). Thus, the term “lobe” is intended to cover any type of audio beam or coverage.

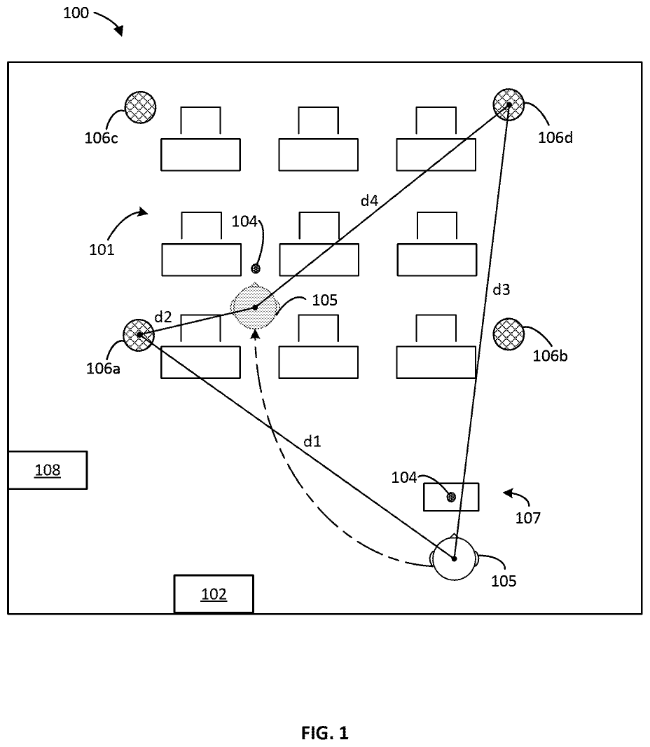

Referring now to FIG. 1, shown is a schematic diagram of an exemplary environment 100 configured to implement one or more techniques for providing dynamic sound reinforcement of an audio source for one or more listeners during a live event, in accordance with embodiments. The environment 100 may be a conference room, boardroom, ballroom, or other meeting space, a classroom, auditorium, lecture hall, congregational venue, or other presentation space, a theater or other performance venue, a fitness studio or gym, an arena or stadium, or any other venue that has an audience area 101 with seating directed towards one side of the event space, such as, e.g., a front of the environment 100, as shown in FIG. 1. For example, in the illustrated embodiment, the audience area 101 comprises a plurality of chairs that are arranged so that audience members seated in respective chairs face the front side of the environment 100.

The environment 100 comprises a computing device 102 configured (e.g., using software instructions stored in a memory) to implement one or more of the dynamic sound reinforcement techniques described herein. The environment 100 further comprises at least one microphone 104 configured to capture sounds generated or produced by a first audio source 105 (or “talker”) located in the environment 100 and convert the captured sounds to audio signals. The environment 100 also comprises one or more sound reinforcement loudspeakers 106 distributed throughout the audience area 101 of the environment 100, or otherwise placed near locations expected to have one or more listeners. The loudspeaker(s) 106 may be configured to play the audio signals generated by the at least one microphone 104, and amplify the audio signals (or microphone signals) as needed to provide appropriate sound reinforcement to the listeners in the audience area 101.

The audio source 105 may be a presenter, performer, or any other person generating sound for an audience during a live event (e.g., a meeting, class, lecture, or other presentation, a musical show, theatrical performance, or other entertainment event, etc.). The sounds produced by the audio source 105 may include any type of audio, including, for example, speech, singing, other voice audio, and music (using a musical instrument or otherwise). The audio source 105 may be initially positioned at or near a presentation area 107 of the environment 100 that is located opposite the audience area 101, or at the front of the environment 100, as illustrated in FIG. 1. The presentation area 107 may include a podium, microphone stand, platform, stage, or other designated space for the audio source 105. As shown, chairs or other seats in the audience area 101 may be arranged so that audience members face the presentation area 107 when seated.

As also shown, the audio source 105 may move from the presentation area 107 into the audience area 101, or otherwise travel closer to at least one of the sound reinforcement loudspeaker(s) 106 (e.g., first loudspeaker 106a). In response to this movement, or upon receiving new location information for the audio source 105, the computing device 102 may be configured to dynamically adjust or change one or more sound reinforcement settings of the loudspeaker(s) 106 so that all listeners in the audience area 101 can hear the audio source 105 equally well (e.g., at the same or substantially same volume). For example, using the techniques described herein, the computing device 102 may be configured to determine or calculate a new sound reinforcement setting (e.g., acoustic gain value) for the first loudspeaker 106a based on the new location of the audio source 105, or more specifically, a current distance between the first loudspeaker 106a and the new audio source location. In general, the computing device 102 may be configured to decrease or increase a sound reinforcement value of each loudspeaker 106 depending on whether the audio source 105 has moved closer to, or further from, that loudspeaker 106. This is because, as the audio source 105 moves closer to a given loudspeaker 106, listeners located near that loudspeaker 106 may start to hear the audio source 105 more clearly or sufficiently well, without the use of sound reinforcement. Conversely, as the audio source 105 moves further away from a given loudspeaker 106, the listeners located near that loudspeaker 106 may require more sound reinforcement in order to hear the audio source 105 sufficiently well.

The new (or current) audio source location information may be determined based on audio activity information associated with the audio source 105, or sounds produced by the audio source 105. For example, the audio activity information (or data) may be obtained or generated by the at least one microphone 104, and/or one or more audio source sensors 108 located in the environment 100, upon detecting audio, motion, or other information in association with the audio source 105. The audio activity data may include any type of information that is suitable for estimating the current (e.g., real-time or near real-time) location of the audio source 105, including, for example, sound localization coordinates (e.g., based on detected sounds), relative position information (e.g., relative to the detecting device, one or more loudspeaker locations, and/or other known locations stored in a memory of the environment 100), proximity information (e.g., distance from the detecting device to the audio source or other component or boundary of the environment 100), and/or any other information obtained in association with detection of the audio source 105.

In some embodiments, each audio source sensor 108, or any combination thereof, is configured to determine or estimate a current location of the audio source 105 based on the audio activity information detected by that sensor 108. In embodiments where the at least one microphone 104 is a portable microphone that travels with the audio source 105, the at least one microphone 104 may be configured to determine and broadcast its own location, e.g., based on sound localization coordinates or other audio activity information obtained by that microphone, and the microphone location may be used as the current location of the audio source 105. In other embodiments, the computing device 102 may be confirmed to aggregate location and/or audio activity data from one or more components of the environment 100 and based thereon, calculate or estimate a current location of the audio source 105, for example, using known techniques. In either case, the current audio source location may represent a real-time or near real-time position of the audio source 105 at the time the audio activity data was detected.

In some embodiments, the current audio source location comprises relative position information and/or distance information, rather than, or in addition to, exact location information (e.g., coordinates). For example, the computing device 102 may be configured to determine, based on the received audio activity data, a proximity (or distance) of the audio source 105 to a known location of the audio system, such as, e.g., one of the loudspeaker locations, one or more boundaries of the audience area 101, the presentation area 107 of FIG. 1, or the overall environment 100, etc. In some cases, the computing device 102 may be configured to use the audio activity data to determine a relative position of the audio source 105, such as, e.g., relative to the audio source sensor 108 or microphone 104 that detected an activity of the audio source 105, relative to the environment 100 as a whole, relative to any of the one or more loudspeakers 106 or other component of the environment 100, and/or relative to a boundary or other demarcation of the audience area 101, the presentation area 107, or other known location in the environment 100.

The at least one microphone 104 may be any type of audio capturing device capable of generating one or more audio signals by detecting or capturing sound from audio sources and converting the sound into the audio signals. According to various embodiments, the at least one microphone 104 may include one or more of an array microphone (e.g., comprised of a plurality of microphone transducers or elements), a non-array microphone (e.g., directional microphones such as lavalier, boundary, etc.), or any other suitable type of audio input device capable of capturing speech and other sounds. The exact type, number, and placement of microphone(s) in a particular environment may depend on the locations of audio sources, listeners, physical space requirements, aesthetics, room layout, stage layout, and/or other considerations. Thus, the microphone(s) 104 may be placed in any suitable location of the environment 100, including on a ceiling, wall, table, lectern, and/or any other surface of the environment 100, or coupled to one or more audio sources in the environment 100. In addition, the microphone(s) 104 may conform to a variety of sizes, form factors, mounting options, and wiring options to suit the needs of the particular environment.

In the illustrated embodiment, the at least one microphone 104 is configured to detect sounds produced at various locations of the environment 100, so as to enable the audio source 105 to move freely about the space during the live event. In some embodiments, the at least one microphone 104 comprises a portable microphone (e.g., a wireless microphone, a handheld microphone, etc.) that is coupled to and/or carried by the audio source 105, for example, as the audio source 105 moves from one location to the next. In other embodiments, the at least one microphone 104 comprises a stationary microphone (e.g., ceiling array microphone, surface array microphone, conferencing device, etc.) that is configured to pick up audio signals from multiple directions or angles, thus enabling the audio source 105 to move at least within an acoustic pick-up range of the microphone 104, for example. In still other embodiments, the at least one microphone 104 comprises a plurality of microphones, including both a portable microphone and one or more stationary microphones, in order to provide a broader range of acoustic pick-up throughout the environment 100 and/or backup options, for example, in case the portable microphone moves out of range, runs out of power, delivers poor quality audio, or otherwise stops working.

In various embodiments, the at least one microphone 104 may include or be communicatively coupled to a beamformer (not shown) for processing the detected audio signals or otherwise generating one or more beamformed audio signals. In such cases, the microphone(s) 104 may be configured to deploy or direct a plurality of audio pick-up beams, or microphone lobes, towards various locations, or at various angles relative to the microphone(s) 104, and the beamformer may be configured to generate the beamformed audio signals by directing one or more of the microphone lobes towards a particular location in the environment 100 (e.g., towards the audio source 105). The beamformer may be included in the microphone(s) 104, may be a standalone device communicatively coupled to the microphone(s) 104, or may be included in the computing device 102. The beamformer may include any type of beamforming algorithm or other beamforming technology configured to deploy microphone lobes, including, for example, a delay and sum beamforming algorithm, a minimum variance distortionless response (“MVDR”) beamforming algorithm, and more. When multiple microphone lobes are used, the beamformer may include a plurality of audio channels, and each channel may be assigned to a respective lobe for individually receiving the audio signal captured by that lobe. For example, the at least one microphone 104 can be configured to generate a plurality of audio signals based on audio captured by the plurality of lobes and provide each of the audio signals to a respective one of a plurality of audio channels at the beamformer. In other embodiments, a beamformer may not be used, for example, in cases where the microphone(s) 104 include a plurality of omnidirectional microphones, each configured to capture audio using an omnidirectional lobe.

For ease of explanation, the techniques described herein may refer to using a plurality of audio signals captured by the microphone(s) 104, even though the techniques may actually utilize any type of acoustic source, including beamformed audio signals generated by the beamformer. In addition, or alternatively, the plurality of audio signals produced by the microphone(s) 104 may be converted into the frequency domain, in which case, certain components of the audio system may operate in the frequency domain.

The one or more sound reinforcement loudspeakers 106 may be any type of audio output device capable of audibly reproducing, or playing out loud, the audio signals generated by the at least one microphone 104 upon detecting or capturing sounds produced by the audio source 105, using one or more of the sound reinforcement techniques described herein. In some embodiments, each of the loudspeaker(s) 106 may be communicatively coupled to the at least one microphone 104 in order to receive the audio signals associated with the audio source 105. In other embodiments, the loudspeaker(s) 106 may be communicatively coupled to the computing device 102, and the computing device 102 may provide each loudspeaker 106 with the appropriate audio signals from the at least one microphone 104.

In general, the loudspeaker(s) 106 may be disposed at various locations around the environment 100 and may include any number of loudspeakers depending on the configuration of the environment 100 and/or the audience area 101. In the illustrated embodiment, for example, the one or more loudspeakers 106 comprises a first loudspeaker 106a located at or near a front, left corner of the audience area 101, a second loudspeaker 106b located at or near a front, right corner of the audience area 101, a third loudspeaker 106c located at or near a back, left corner of the audience area 101, and a fourth loudspeaker 106d located at or near a back, right corner of the audience area 101. As will be appreciated, in other embodiments, the environment 100 may include more or fewer loudspeakers 106 and/or loudspeaker(s) 106 located at different locations than those shown. The one or more loudspeakers 106 may be mounted to, or suspended from, a ceiling of the environment 100, attached to a wall of the environment 100, placed on any other surface in the environment 100 (e.g., a table, lectern or podium, desk or other table top, etc.), or otherwise disposed in or around the audience area 101. In some embodiments, the loudspeaker locations may be fixed or at least semi-permanent. In other embodiments, the loudspeaker(s) 106 may be movable to new locations, for example, as needed to accommodate the layout of the audience area 101, etc.

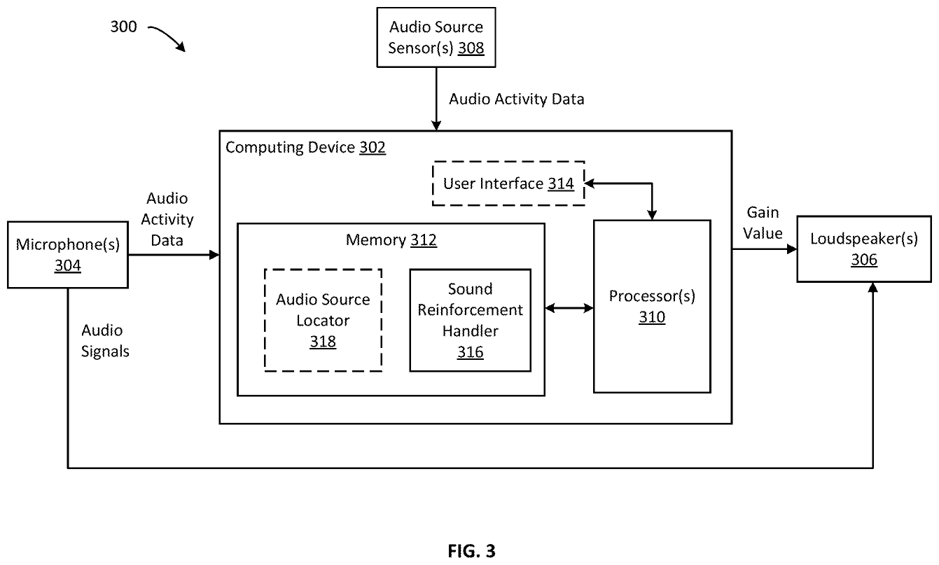

According to embodiments, information describing the exact location of each loudspeaker 106, or a relative position of the loudspeaker 106 within the environment 100, may be stored in a memory (e.g., memory 312 shown in FIG. 3) and retrieved by the computing device 102 for calculation of an appropriate sound reinforcement setting for that loudspeaker 106. Such loudspeaker location information may include location coordinates (e.g., relative to a coordinate system of the loudspeaker, a coordinate system of the at least one microphone 104, a uniform coordinate system for the environment 100, or other suitable coordinate system), distance measurements (e.g., relative to the at least one microphone 104, one or more walls of the environment 100, or other component of the environment 100), or any other information that identifies, or can be used to determine, the loudspeaker position.

Location information for each of the loudspeakers 106 may be automatically discovered, collected, or otherwise determined using the computing device 102 prior to the live event. For example, during initial set-up or installation of the loudspeaker 106, the engineer or installer may use a configuration tool that operates on the computing device 102 or other computer (e.g., Designer, Wireless Work Bench, and other similar desktop software applications), a similar tool that operates on a mobile device (e.g., MOTIV, Wireless Work Bench, and other similar mobile software applications), or any other suitable software program configured to collect or obtain location information for the one or more loudspeakers 106 in the environment 100. In some embodiments, each loudspeaker 106 may be configured to broadcast or provide its known location information to the computing device 102 (e.g., retrieved from a memory of the loudspeaker 106). In other embodiments, the loudspeaker location information may be determined based on information entered by the user, for example, into the computing device 102 (e.g., using user interface 314 of FIG. 3). In still other embodiments, the loudspeaker location information may be determined or estimated based on audio activity information obtained from the loudspeaker 106, the at least one microphone 104, the computing device 102, and/or one or more other components of the environment 100, using known techniques.

The one or more audio source sensors 108 may be any type of audio and/or motion detecting device, or other sensing device, capable of determining a real-time, or near real-time, location of the audio source 105 (also referred to herein as “current audio source location”), and/or capable of gathering information (e.g., audio activity data) that can be used to calculate the current audio source location. In some embodiments, the audio source sensor(s) 108 may be configured to obtain audio activity information associated with the audio source 105, the at least one microphone 104 (where the microphone 104 is portable), and/or the environment 100 at large, and use that information to estimate a current location of the audio source 105. In embodiments, the one or more audio source sensors 108 may include, but are not limited to, an infrared sensor or other motion sensor; a time of flight (“ToF”) sensor or other camera or image-capture-based sensor; a microphone array, (e.g., a ceiling array microphone, such as, but not limited to Shure's MXA920, etc.), other audio detector or audio activity sensor; RADAR or other radio wave-based sensor; a light detection and ranging (“LiDAR”) sensor or other laser-based sensing device; a telemetry sensor on the at least one microphone 104 and/or the audio source 105, or any combination thereof.

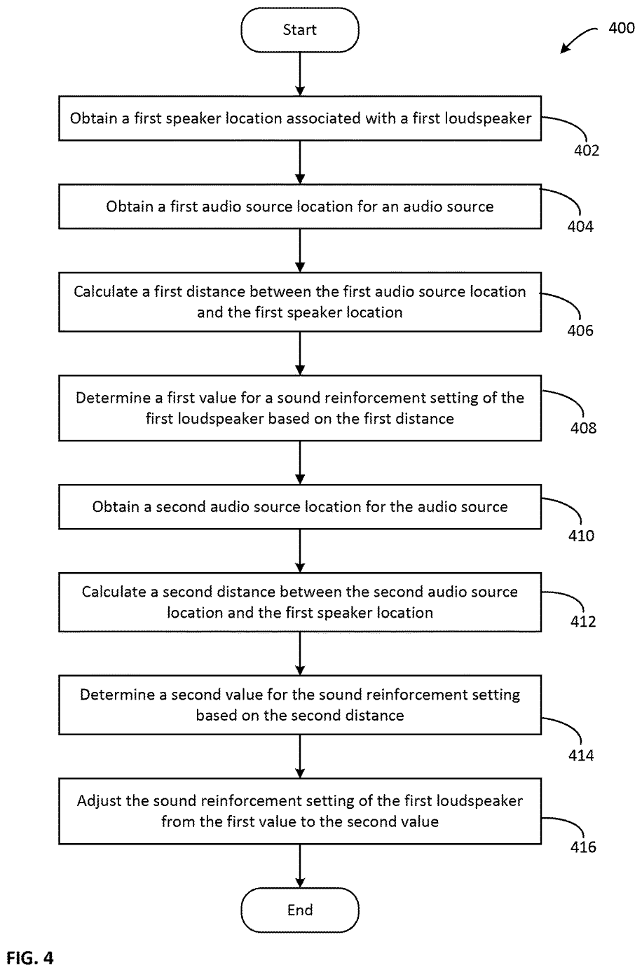

The computing device 102 can be any generic computing device comprising one or more processors and a memory device for storing software instructions or algorithms (e.g., as shown in FIG. 3). The computing device 102 may be configured to implement one or more of the dynamic sound reinforcement techniques described herein upon executing software instructions stored in the memory device (e.g., process 400 shown in FIG. 4). In embodiments, the at least one microphone 104, the one or more loudspeakers 106, and the one or more audio source sensors 108 (collectively referred to herein as “audio devices”) may be connected, coupled to, or otherwise in communication with the computing device 102 via a wired connection or a wireless network connection. The computing device 102 may be located anywhere in the environment 100, including, for example, on a table, counter, or other surface, in a separate unit or cabinet, integrated into or coupled to one or more other components of the environment 100, etc. In some embodiments, all or portions of the computing device 102 may be at least partially located or stored on a remote server that is in communication with other components of the environment 100 (e.g., a cloud-based computing device). Though not shown, it should be appreciated that the environment 100 may include other devices not shown in FIG. 1, such as, for example, a video camera or other image capturing device, one or more additional audio reproduction devices or speakers for playing far end audio during a conference call, telecast, webcast, etc., and more. These other components may also be communicatively coupled to the computing device 102 using a wired or wireless connection.

In embodiments, the computing device 102, the at least one microphone 104, the one or more loudspeakers 106, and the one or more audio source sensors 108, as well as any other audio devices in the environment 100, may form an audio system (such as, e.g., audio system 300 shown in FIG. 3) configured to implement one or more of the dynamic sound reinforcement techniques described herein. For example, the computing device 102 can be configured to receive, from the one or more sensors 108 and/or the at least one microphone 104, information that describes, or can be used to determine, a current, or currently-detected, location of the audio source 105. The computing device 102 can also be configured to receive, or have stored in a memory (e.g., memory 312 of FIG. 3), the location of each sound reinforcement loudspeaker 106 included in the audio system or otherwise located in the environment 100. The computing device 102 can be further configured to use the current audio source location and the known loudspeaker locations to determine appropriate values for the sound reinforcement settings of the one or more loudspeakers 106 and dynamically adjust those settings accordingly, so that all listeners in the audience area 101 can hear the audio source 105 equally or similarly well, even as the audio source 105 moves about the environment 100. For example, the sound reinforcement setting may comprise an acoustic gain setting that is applied to the reinforcement signal, or the audio signal provided to the corresponding loudspeaker 106 for playback, or any other loudspeaker setting that controls gain, volume, or amplification of audio signals output by the loudspeaker 106. In such cases, the computing device 102 may calculate an appropriate acoustic gain value, or the like, for the reinforcement signal provided to each loudspeaker 106 based on a relative distance from the current location of the audio source 105, and adjust the acoustic gain setting of each loudspeaker 106 accordingly, for example, using the techniques described in co-owned U.S. Application No. 63/761,452, entitled “Automated Local Audio Reinforcement and Voice Lift Systems and Methods,” the entire contents of which is incorporated by reference herein.

In various embodiments, the audio system further comprises a sound reinforcement handling component (e.g., sound reinforcement handler 316 shown in FIG. 3) that is in communication with, or included in, the computing device 102 and is configured to implement one or more of the dynamic sound reinforcement techniques described herein, as further elaborated with respect to FIG. 3. The audio system may also comprise an audio source locating component (or “audio source locator,” as shown in FIG. 3) configured to determine the current location (e.g., in real-time or near real-time) of the audio source 105 based on audio activity data associated with the audio source 105, or the sounds produced thereby, as further described with respect to FIG. 3. The audio source locator may receive the audio activity data from the one or more audio source sensors 108 and/or the at least one microphone 104, for example. Once a current location of the audio source 105 is determined, the audio source locator may provide the current audio source location to the computing device 102 and/or the sound reinforcement handler to control or adjust one or more sound reinforcement settings of the one or more loudspeakers 106 accordingly.

According to embodiments, each of the audio source locator and the sound reinforcement handler may be a software module executed by one or more processors (e.g., an audio processor) of the computing device 102 (e.g., processor(s) 310 of FIG. 3) or the larger audio system. All or a portion of each module may be stored in a memory of the computing device 102 (e.g., memory 312 of FIG. 3), any of the one or more audio source sensors 108, the at least one microphone 104, or any another component of the audio system having at least one processing device. In some cases, all or a portion of each of the audio source locator and the sound reinforcement handler may be stored in a cloud computing device or system (not shown) that is in communication with the one or more processors or other components of the audio system.

Referring back to FIG. 1, the dynamic sound reinforcement adjustment techniques of the audio system shown therein may begin with the computing device 102 initially configuring the sound reinforcement settings of each of the loudspeakers 106a, 106b, 106c, and 106d based on an initial location the audio source 105, for example, at the start of the live event. As shown, the audio source 105 may be initially positioned at a first audio source location included within the presentation area 107 of the environment 100, or more specifically, next to a podium or microphone stand located in the presentation area 107. The at least one microphone 104 may generate first audio signals (or “microphone signals”) based on sounds produced by the audio source 105 while standing by the podium and may send the first audio signals to each of the sound reinforcement loudspeakers 106a 106b, 106c, and 106d, in order to create appropriate amplification of the signals throughout the audience area 101. In response, the computing device 102 can be configured to tailor the amount of amplification, or reinforcement, applied to the microphone signals playing on each of the loudspeakers 106a, 106b, 106c, and 106d based on the distance from that loudspeaker to the current audio source location, so that listeners located closer to the audio source 105 receive proportionally less amplification than listeners located further away.

In embodiments, the computing device 102 and/or the audio source locator may be configured to determine or identify the first audio source location based on initial (or first) audio activity data obtained in association with the audio source 105, or sounds produced thereby, while the audio source 105 is positioned at that initial location (e.g., next to the podium in the presentation area 107). Once the first audio source location is determined, the computing device 102 and/or the sound reinforcement handler may be configured to calculate a first distance (e.g., d1 in FIG. 1) between a previously-known location of the first loudspeaker 106a (or “first speaker location”) and the first audio source location, and based on the first distance, determine or calculate a first value for the sound reinforcement setting of the first loudspeaker 106. In embodiments where the sound reinforcement setting is an acoustic gain setting of the first loudspeaker 106, for example, the first value may be configured to set the acoustic gain of microphone signals played by the first loudspeaker 106 to a level that is proportional to the first distance, or loud enough for listeners near the first loudspeaker 106 to clearly hear the microphone signals associated with the audio source 105. In addition, the computing device 102 may be configured to apply the first value to the sound reinforcement setting of the first loudspeaker 106a, for example, by sending the first value to the first loudspeaker 106a with instructions to change or set its sound reinforcement setting to the first value, or otherwise instructing the first loudspeaker 106a to do so.

During the live event, the audio source 105 may travel away from the presentation area 107, for example, by moving from the first audio source location to a different, or second, audio source location that is within the audience area 101. As shown in FIG. 1, such movement may bring the audio source 105 closer to, or further from, one or more of the sound reinforcement loudspeakers 106a, 106b, 106c, and 106d, which can affect the amount of sound reinforcement needed from each of the loudspeakers 106 to enable the audio source 105 to be sufficiently audible throughout the audience area 101. In some embodiments, the audio source 105 may carry or take the at least one microphone 104 with them from the first location to the second location, for example, where the microphone 104 is a wireless or handheld microphone. In other embodiments, the at least one microphone 104 may comprise a first microphone 104 that is fixedly positioned in the presentation area 107 (e.g., a gooseneck microphone placed on the podium, a wired microphone attached to a microphone stand, a microphone array, etc.) and a second microphone 104 that is positioned within the audience area 101 (e.g., a ceiling array microphone or the like). In such cases, the second microphone 104 may be configured to capture sounds produced by the audio source 105, for example, upon detecting the audio source 105 with an acoustic pick-up range of the second microphone 104 (e.g., within an audio coverage area, audio pick-up zone, etc.) and/or once the audio source 105 moves into the audience area 101 or out of an acoustic pick-up range of the first microphone 104. In either case, the at least one microphone 104 may generate second audio signals based on sounds captured while the audio source 105 is located at the new or second audio source location and may provide the second audio signals (or microphone signals) to the sound reinforcement loudspeakers 106a, 106b, 106c, and 106d for appropriate amplification based on the second audio source location.

More specifically, the computing device 102 and/or the audio source locator can be configured to determine or calculate the second audio source location based on new (or second) audio activity data obtained in association with the audio source 105, or sounds produced thereby, after the audio source 105 moves from the first audio source location. For example, the audio source locator may determine that the audio source 105 has moved from the first audio source location by comparing the first audio activity data to the second audio activity data, or other audio activity data received at a later point in time, and determining that the two sets of data are different, or do not match. Once the second audio source location is determined (e.g., next to first loudspeaker 106a in the audience area 101), the computing device 102 and/or the sound reinforcement handler can be configured to calculate a second distance (e.g., d2 in FIG. 1) between the first speaker location associated with the first loudspeaker 106a and the second audio source location associated with the audio source 105. The computing device 102 and/or the sound reinforcement handler can also be configured to use the second distance to determine a second, different value for the sound reinforcement setting of the first loudspeaker 106a, so that the sound reinforcement effect provided by the first loudspeaker 106a can be proportionally adjusted for the new audio source location. In addition, the computing device 102 and/or the sound reinforcement handler can be further configured to adjust or change the sound reinforcement setting of the first loudspeaker 106a from the first value to the second value, or otherwise set the sound reinforcement setting to the second value.

In the illustrated embodiment, for example, because the second audio source location is located closer to the first loudspeaker 106a (i.e. the second distance d2 is less than the first distance d1), listeners near the first loudspeaker 106a may hear the audio source 105 sufficiently well without much, or any, sound reinforcement, compared to when the audio source 105 was located at the first location near the presentation area 107. Accordingly, the sound reinforcement handler may calculate or select a second value for the sound reinforcement setting of the first loudspeaker 106a that is less than the first value calculated based on the first distance d1, or otherwise dynamically decrease the amount of amplification applied to microphone signals playing on the first loudspeaker 106a based on the current audio source location. For example, in embodiments where the sound reinforcement setting comprises the acoustic gain setting, the second value may be a lower acoustic gain value for the first loudspeaker 106a.

The same or similar dynamic adjustment techniques may be applied to the other sound reinforcement loudspeakers 106b, 106c, and 106d in the audio system until the sound reinforcement setting of each loudspeaker 106 has been proportionally increased or decreased, as needed, to accommodate the current audio source location. For example, in FIG. 1, the computing device 102 and/or the sound reinforcement handler may be further configured to initially calculate a third distance d3 between the first audio source location and a location of a fourth loudspeaker 106d, as shown; determine an initial value (also referred to herein as “third value”) for a sound reinforcement setting of the fourth loudspeaker 106d based on the third distance; and apply or implement the initial sound reinforcement value at the fourth loudspeaker 106d. Once the audio source 105 moves to the second audio source location, the computing device 102 and/or the sound reinforcement handler may be further configured to calculate a fourth distance d4 between the second audio source location and the fourth loudspeaker location, as shown; determine, based on the fourth distance, a new value (also referred to herein as “fourth value”) for the sound reinforcement setting of the fourth loudspeaker 106d; and adjust the sound reinforcement setting of the fourth loudspeaker 106d from the third value to the fourth value, or otherwise apply the fourth sound reinforcement value to the fourth loudspeaker 106d. As shown, since the fourth distance d4 is smaller than the third distance d3 (i.e. the second audio source location is closer to the fourth loudspeaker 106d than the first audio source location), the new sound reinforcement value may be correspondingly smaller than the initial sound reinforcement value, such that the microphone signals output by the fourth loudspeaker 106d are less amplified or reinforced while the audio source 105 is located at the second audio source location.

According to embodiments, the computing device 102 and/or the sound reinforcement handler can be configured to use any suitable formula, equation, or other technique to calculate an appropriate value for the sound reinforcement setting of each loudspeaker 106 based on a relative distance to the audio source 105, to allow subtle gain, or amplification, changes as the audio source 105 moves about the environment 100 during a live event. For example, in one exemplary embodiment, the sound reinforcement handler may be configured to calculate the appropriate reinforcement gain value for a given loudspeaker 106 using Equation 1, where D0 is the distance from the audio source 105 to a listener located near the given loudspeaker 106, D1 is the distance from the microphone 104 to the loudspeaker 106, D2 is the distance from the listener to the loudspeaker 106, and DS is the distance from the audio source 105 to the microphone 104.

$$PAG = 20 log D 1 - 20 log D 2 + 20 log D 0 - 20 log DS - 10 log NOM - 6 \qquad Equation 1$$

In other embodiments, the sound reinforcement handler may be configured to use other equations or techniques to calculate an appropriate reinforcement gain for each loudspeaker 106 based on the current location of the audio source 105 relative to that loudspeaker 106, including, for example, the techniques described in co-owned U.S. Application No. 63/761,452, the entire contents of which is incorporated by reference herein, as mentioned above.

In some embodiments, the audio system can be configured to automatically turn off or minimize the sound reinforcement effect once the audio source 105 moves close enough to the given loudspeaker 106 that sound reinforcement for listeners near that loudspeaker 106 is unnecessary (e.g., because the nearby listeners can hear the audio source 105 sufficiently well without it) and/or undesirable (e.g., because reinforcing the microphone signals would result in an audio feedback loop and/or create an echo for the nearby listeners). In this manner, the audio system can provide listeners located close to a current audio source location with a natural transition to the original speech or sounds produced by the audio source 105, instead of reinforced audio playing on the nearby loudspeaker 106.

More specifically, the computing device 102 and/or the sound reinforcement handler can be configured to activate or enable a sound reinforcement setting of a given loudspeaker 106 only when the current audio source location is sufficiently far from that loudspeaker 106, or at least a threshold distance from the loudspeaker location. For example, in some cases, the threshold distance (or threshold distance value) may be about eight feet, about ten feet, or any value between eight and ten feet. In some cases, the threshold distance may vary depending on the type of loudspeaker used for sound reinforcement, characteristics of the venue or environment 100, the type of live event, and other factors. During the live event, the sound reinforcement handler can be configured to compare a newly-calculated distance between a current audio source location and a given loudspeaker location (e.g., second distance d2 or fourth distance d4 in FIG. 1) to the threshold distance. If the new distance is less than the threshold distance (i.e. the current audio source location is close to the loudspeaker location), the sound reinforcement handler may select a zero value for the sound reinforcement setting of the corresponding loudspeaker 106, or otherwise turn off the sound reinforcement effect from that loudspeaker 106. This allows listeners located near the current audio source location to hear only the original speech or sounds of the audio source 105. Conversely, if the new distance is greater than or equal to the threshold distance, the sound reinforcement handler may gradually transition into a value greater than zero and go up to the maximum allowed volume for the sound reinforcement setting of the corresponding loudspeaker 106, for example, using the above-described techniques. The sound reinforcement setting may be gradually adjusted to meet a given target value using an exponential decay or growth formula (as appropriate), or other suitable rate of change.

For example, FIG. 1 shows the second audio source location as being very close to the location of the first loudspeaker 106a. In some embodiments, the sound reinforcement handler may determine that the second distance d2 is less than the threshold distance and thus, may turn off, or set to zero, the sound reinforcement setting of the first loudspeaker 106a. As a result, listeners located near second audio source location may be able to hear the original sounds produced by the audio source 105. Also in FIG. 1, the fourth loudspeaker 106d is located far from the second audio source location, such that the fourth distance d4 may exceed the threshold distance. As a result, the fourth loudspeaker 106d may be configured to provide a sound reinforcement effect based on the fourth distance d4, as described herein.

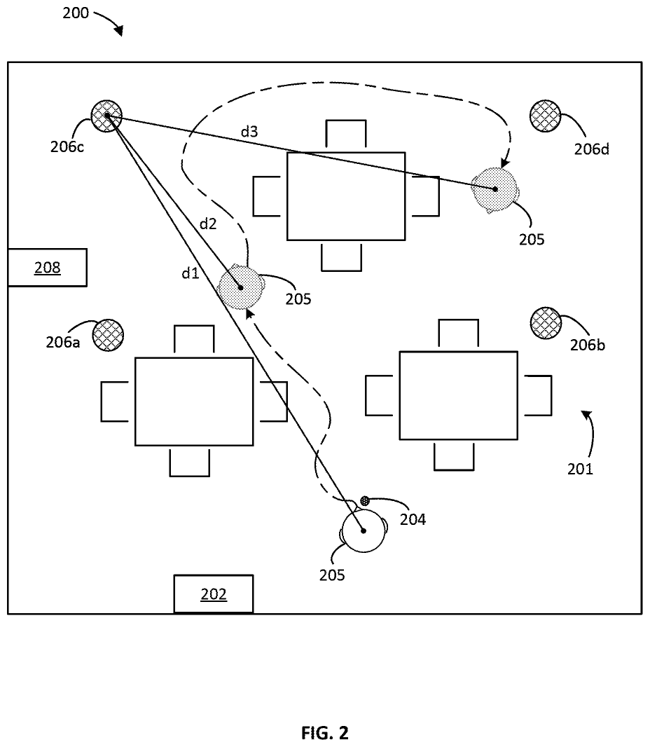

Referring now to FIG. 2, shown is a schematic diagram of another exemplary environment 200 configured to implement one or more techniques for providing dynamic sound reinforcement of an audio source for one or more listeners during a live event, in accordance with embodiments. The environment 200 may be a conference room, meeting room, ballroom, wedding hall, event space, performance hall, restaurant, classroom, or any other venue that has an audience area 201 with seating distributed throughout the space and facing towards various directions, as shown in FIG. 2. For example, in the illustrated embodiment, the audience area 201 comprises a plurality of chairs disposed around a plurality of tables, so that audience members seated in respective chairs at a given table face each other across the table, rather than one side of the environment 200 (e.g., unlike the environment 100 in FIG. 1). Moreover, as shown in FIG. 2, the tables in the audience area 201 are spaced apart enough to allow an audio source 205 (e.g., presenter, performer, or other talker) to walk between the tables while moving about the environment 200 during a live event. In the illustrated embodiment, the environment 200 does not include a dedicated presentation area where, for example, the audio source 205 can begin the live event (e.g., unlike the environment 100 of FIG. 1). In other embodiments (not shown), the environment 200 may also include a presentation area (e.g., stage, podium, pulpit, microphone stand, etc.) at one side (e.g., front) of the environment 200, for example, similar to the presentation area 107 in FIG. 1.

The audio source 205 may be substantially similar to the audio source 105 shown in FIG. 1, and may produce substantially similar sounds while moving through the environment 200. Other components of the environment 200 may also be substantially similar to, or the same as, corresponding components of the environment 100 shown in FIG. 1. In certain embodiments, the environment 200 may be the same as the environment 100, except for the arrangement of the audience area 201. For example, the environment 200 comprises a computing device 202 that is configured to implement one or more of the dynamic sound reinforcement techniques described herein, and is substantially similar to the computing device 102. The environment 200 further comprises at least one microphone 204 that is configured to capture sounds produced by the audio source 205 during a live event, and is substantially similar to the at least one microphone 104. The environment 200 also comprises one or more sound reinforcement loudspeakers 206 (e.g., comprising loudspeakers 206a, 206b, 206c, and 206d) that are configured to play audio signals received from the at least one microphone 204 for sound reinforcement purposes throughout the environment 200, and are substantially similar to the one or more loudspeakers 106 (e.g., comprising loudspeakers 106a, 106b, 106c, and 106d). In addition, the environment 200 comprises one or more audio source sensors 208 that are configured to detect audio activity information associated with the audio source 205 to determine a current (e.g., real-time or near real-time) location of the audio source 205, and are substantially similar to, or the same as, the one or more audio source sensors 108. Moreover, the computing device 202, the at least one microphone 204, the one or more loudspeakers 206, and the one or more sensors 208 can be configured to operate as an audio system that is substantially similar to, or the same as, the audio system of environment 100, as described above with reference to FIG. 1. To that end, the audio system of environment 200 may further comprise an audio source locator and/or a sound reinforcement handler that is substantially similar to the audio source locator and the sound reinforcement handler, respectively, included in the audio system of environment 100. Accordingly, further detail about the similar components of the environment 200, and their respective operation, will not be described again, for the sake of brevity.

As shown in FIG. 2, during the live event, the audio source 205 may move from an initial location at a first side of the environment 200 to a second location near a center of the audience area 201, and then to a third location near a second side of the environment 200 that is generally opposite the first side. During these location changes, the audio source 205 may carry the at least one microphone 204 on their person or in their hand, and may move closer to, or further from, each of the sound reinforcement loudspeakers 206a 206b, 206c, and 206d, thus changing the amount of sound reinforcement needed at each loudspeaker 206. The computing device 202 and/or the sound reinforcement handler can be configured to provide dynamic sound reinforcement for listeners throughout the environment 200 as the audio source 205 moves about the space, by applying subtle gain or amplification changes to the microphone signals being output or played by each loudspeaker 206 based on the distance between that loudspeaker 206 and a current (e.g., real-time or near real-time) location of the audio source 205 at select points in time.

For example, at a first point in time, while the audio source 205 is located at the initial or first audio source location, the computing device 202 and/or the sound reinforcement handler may calculate a first distance d1 between the first audio source location and the location of the third loudspeaker 206c, and based on the first distance, may determine a first value for a sound reinforcement setting of the third loudspeaker 206c. At a second point in time, while the audio source 205 is located at the second audio source location, the computing device 202 and/or the sound reinforcement handler may calculate a second distance d2 between the second audio source location and the location of the third loudspeaker 206c. As shown in FIG. 2, the second distance d2 is less than the first distance d1 because the second audio source location is closer to the third loudspeaker 206c than the first audio source location. As a result, listeners near the third loudspeaker 206c may now require less sound reinforcement than when the audio source 205 was at the first location. Accordingly, the computing device 202 and/or the sound reinforcement handler may be configured to determine, based on the second distance, a second value for the sound reinforcement setting of the third loudspeaker 206c that is less than the first value determined based on the first distance. The computing device 202 may also be configured to adjust the sound reinforcement setting of the third loudspeaker 206c from the first value to the second value, or otherwise cause the third loudspeaker 206c to change the sound reinforcement setting accordingly.

As a further example, at a third point in time, while the audio source 205 is located at the third audio source location, the computing device and/or the sound reinforcement handler may calculate a third distance d3 between the third audio source location and the location of the third loudspeaker 206c. As shown, the third distance d3 is greater than the second distance d2 because the third audio source location is further away from the third loudspeaker 206c than the second audio source location. As a result, listeners near the third loudspeaker 206c may need more sound reinforcement while the audio source 205 is at the third location than when the audio source 205 is at the second location. However, because the third distance is smaller than the first distance, the amount of sound reinforcement needed while the audio source 205 is at the third location is less than the amount of sound reinforcement needed while the audio source 205 is at the first location. Accordingly, the computing device 202 and/or the sound reinforcement handler may be configured to determine, based on the third distance, a third value for the sound reinforcement setting of the third loudspeaker 206c that is greater than the second value determined based on the second distance, and less than the first value determined based on the first distance. The computing device 202 may also be configured to adjust the sound reinforcement setting of the third loudspeaker 206c from the second value to the third value, or otherwise cause the third loudspeaker 206c to make that change.

Also like the audio system of FIG. 1, the computing device 202 and/or the sound reinforcement handler can be configured to activate or enable sound reinforcement effects at a given loudspeaker 206 only when the audio source 205 is located sufficiently far from that loudspeaker 206, or at least a threshold distance away from the loudspeaker location, to avoid creating a feedback loop or other undesirable effect. For example, in FIG. 2, after the audio source 205 moves from the second audio source location to the third audio source location, the sound reinforcement handler may determine that the fourth loudspeaker 206d is located less than the threshold distance from the third audio source location and thus, may turn off the sound reinforcement setting of the fourth loudspeaker 206d, or change the setting to a zero value.

Thus, the audio system of the environment 100/200 can be configured to dynamically adjust sound reinforcement effects provided by one or more loudspeakers 106/206 during a live event based on a current audio source location. This provides a consistent listener experience as listeners throughout the audience area 101/201 can hear sounds produced by the audio source 105/205 sufficiently well, and without audio feedback, even as the audio source 105/205 moves about the environment 100/200 while carrying the at least one microphone 104/204. In addition, the techniques described herein enable the audio source 105/205 to cover, or perform from, additional areas of the environment 100/200, rather than being limited to a specific stage area or the like for the entire event.

While FIGS. 1 and 2 show a specific room configuration, it should be appreciated that other arrangements of the audience and presentation areas, audio devices, and/or audio sources are contemplated and possible, including, for example, different arrangements of the chairs and/or tables in the audience area, different overall configurations for the presentation area and the audience area, a different number and/or placement of loudspeakers and/or microphones, different number of audio sources, and more.

Referring now to FIG. 3, shown is an exemplary audio system 300 configured to implement one or more of the dynamic sound reinforcement operations described herein, in accordance with embodiments. As shown, the audio system 300 comprises a computing device 302 and one or more audio devices. The audio devices can include at least one microphone 304, one or more loudspeakers 306, and/or other types of audio devices (e.g., conferencing device, etc.). In some embodiments, the audio system 300 further includes one or more audio source sensors 308, which may also be an audio device (e.g., a microphone or other audio detecting device). It should be appreciated that, while the illustrated embodiment shows one microphone 304, one loudspeaker 306, and one audio source sensor 308, in other embodiments, the audio system 300 may include multiple microphones 304, multiple loudspeakers 306, and/or multiple audio source sensors 308.

In various embodiments, each of the audio systems included in the environments 100 and 200 (as shown in FIGS. 1 and 2, respectively) may be implemented using the audio system 300. For example, each of the computing devices 102 and 202 may be implemented using the computing device 302, each of the microphones 104 and 204 may be implemented using the at least one microphone 304, each of the loudspeakers 106 and 206 may be implemented using the one or more loudspeakers 306, and each of the audio source sensors 108 and 208 may be implemented using the one or more audio source sensors 308. Accordingly, certain overlapping features of the common components of audio system 300 will not be described again in detail, for the sake of brevity.

The computing device 302 may be communicatively coupled to each of the audio devices using a wired connection (e.g., Ethernet, USB or other suitable type of cable) or a wireless network connection (e.g., WiFi, Bluetooth, Near Field Communication (“NFC”), RFID, infrared, etc.). For example, the microphone 304 may be a wireless microphone that can be carried by the audio source (e.g., audio source 105 in FIG. 1) as they move about the room. In some embodiments, one or more of the microphone 304 and the loudspeaker 306 may be network audio devices coupled to the computing device 302 via a network cable (e.g., Ethernet) and configured to handle digital audio signals. In other embodiments, the audio devices of the audio system 300 may be analog audio devices or another type of digital audio device, and may be connected to the computing device 302 using a Universal Serial Bus (USB) cable or other suitable connection mechanism.

According to various embodiments, one or more components of the audio system 300 may be embodied in a single hardware device. For example, one or more of the microphone(s) 304 and one or more of the loudspeaker(s) 306 may be included in a single audio device (e.g., a network audio device or the like). As another example, one or more of the microphone(s) 304 and the loudspeaker(s) 306 may be included in the computing device 302, for example, as a native or built-in audio speaker or microphone.

In some embodiments, the computing device 302 can be physically located in and/or dedicated to the given environment or room, for example, as shown in FIGS. 1 and 2. In other embodiments, the computing device 302 can be part of a network and/or distributed in a cloud-based environment. In various embodiments, the computing device 302 resides in an external network, such as a cloud computing network. In some embodiments, the computing device 302 may be implemented with firmware or completely software-based as part of a network, which may be accessed or otherwise communicated with via another device, including other computing devices, such as, e.g., desktops, laptops, mobile devices, tablets, smart devices, etc.

As shown in FIG. 3, the computing device 302 may comprise one or more processors 310, a memory 312, and/or a user interface 314 for carrying out the techniques described herein, including providing dynamic sound reinforcement of microphone signals during a live event. The components of the computing device 302 may be communicatively coupled by system bus, network, or other connection mechanism (not shown). In various embodiments, the computing device 302 may be a personal computer (PC), a laptop computer, a tablet, a smartphone or other smart device, other mobile device, thin client, a server, or other computing platform. In such cases, the computing device 302 may further include other components commonly found in a PC or laptop computer, such as, e.g., a data storage device, a native, or built-in, microphone device, and a native audio speaker device. In some embodiments, the computing device 302 is a standalone computing device, such as, e.g., the computing device 102 shown in FIG. 1, or other control device that is separate from the other components of the audio system 300. In other embodiments, the computing device 302 resides in another component of the audio system 300, such as, e.g., the at least one microphone 304, the one or more loudspeakers 306, etc.

The one or more processors 310 execute instructions retrieved from the memory 312. I embodiments, the memory 312 stores one or more software programs, or sets of instructions, that embody the techniques described herein. When executed by the processor 310, the instructions may cause the computing device 302 to implement or operate all or parts of the techniques described herein, one or more components of the audio system 300, and/or methods, processes, or operations associated therewith, such as, e.g., process 400 shown in FIG. 4. For example, as shown in FIG. 3, the memory 312 may include a sound reinforcement handling component or software module 316 (also referred to herein as “sound reinforcement handler”) that is configured to cause the computing device 302, or any of the one or more processors 310, to dynamically adjust sound reinforcement settings of the one or more loudspeakers 306 based on a currently-detected location of an audio source, or otherwise carry out one or more operations of process 400 shown in FIG. 4. As another example, in some embodiments, the memory 312 may include an audio source locating component or software module 318 (also referred to herein as “audio source locator”) that is configured to cause the computing device 302, or any of the one or more processors 310, to analyze audio activity information associated with a detected audio source and identify or determine a current (e.g., real-time or near real-time) location of the audio source, or otherwise carry out one or more operations of process 400 shown in FIG. 4.

In general, the computing device 302 can be configured to control and communicate or interface with the other hardware devices included in the audio system 300, such as the microphone(s) 304, the loudspeaker(s) 306, the one or more audio source sensors 308, and/or any other devices in the same network. The computing device 302 may also control or interface with certain software components of the audio system 300. For example, in some embodiments, the audio source locator 318 may be a separate software module that is installed on or included in the at least one microphone 304, or another component of the audio system 300. In such cases, the computing device 302 may be configured to interface with the audio source locator 318 in order to receive the audio source location information that is used by the sound reinforcement handler 316 to provide dynamic sound reinforcement. As another example, in some embodiments, the sound reinforcement handler 316 may be a separate software module that is installed on or included in one or more of the sound reinforcement loudspeaker(s) 306, or another component of the audio system 300. In such cases, the computing device 302 may be configured to interface with the sound reinforcement handler in order to receive appropriate values for dynamically configuring the sound reinforcement settings of the loudspeakers 306.

The computing device 302 may include one or more communication interfaces (e.g., hardware or software-based) that are configured to enable the computing device 302 to communicate with other devices (or systems) according to one or more protocols, as will be appreciated. For example, the communication interface may enable the computing device 302 to transmit information to, and receive information from, the microphone(s) 304, the loudspeaker(s) 306, the audio source sensor(s) 208, and/or other component(s) of the audio system 300. Such information may include, for example, location information for each of the one or more loudspeakers 306, audio activity information (such as, e.g., sound localization coordinates) or other location data associated with a detected audio source. In some embodiments, the computing device 302 may operate as an aggregator configured to aggregate or collect the loudspeaker location information from each of the one or more loudspeakers 306, or the audio activity information and/or other location data from appropriate audio devices, like the microphone(s) 304 and/or the audio source sensor(s) 308.

In some cases, the computing device 302 may be configured to communicate or interface with external components coupled to the audio system 300 (e.g., remote servers, databases, and other devices). For example, the computing device 302 may interface with a component graphical user interface (GUI or CUI) associated with the audio system 300 and any existing or proprietary software, such as, e.g., conferencing software or other presentation software. In addition, the computing device 302 may support one or more third-party controllers and in-room control panels (e.g., volume control, mute, etc.) for controlling one or more of the audio devices in the audio system 300.

User interface 314 may facilitate interaction with a user of the computing device 302 and/or audio system 300. As such, the user interface 314 may include input components such as a keyboard, a keypad, a mouse, a touch-sensitive panel, a microphone, and a camera, and output components such as a display screen (which, for example, may be combined with a touch-sensitive panel), a sound speaker, and a haptic feedback system. The user interface 314 may also comprise devices that communicate with inputs or outputs, such as a short-range transceiver (RFID, Bluetooth, etc.), a telephonic interface, a cellular communication port, a router, or other types of network communication equipment. The user interface 314 may be internal to the computing device 302, or may be external and connected wirelessly or via connection cable, such as through a universal serial bus port. In some embodiments, the user interface 314 may include a button, touchscreen, or other input device for receiving a user input for controlling one or more sound reinforcement settings defined by the computing device 302 and/or implementing other user-initiated actions described herein. In some embodiments, the user interface 314 may be used to implement an interactive graphical user interface or other tool for enabling the user to control and/or adjust one or more sound reinforcement settings, as described herein.

The at least one microphone 304 may be any type of microphone, including one or more individual microphones (or microphone transducers), a microphone array (or a plurality of microphone transducers arranged in an array), or other audio input device capable of capturing speech, vocals, and other sounds associated with a live audio event, such as, e.g., a conference call or meeting, webcast, telecast, class or lecture, presentation, performance, etc. In embodiments, the at least one microphone 304 is configured to capture near-end audio associated with the audio event, such as sounds produced by a presenter, performer, talker, or other audio source of the event. In various embodiments, the microphone(s) 304 may be a wireless microphone, a handheld microphone, or other type of portable audio capturing device that can be attached to or carried by an audio source (e.g., talker) and travel with the audio source as they move about the environment. In some embodiments, the microphone(s) 304 may be a standalone network audio device or a native microphone built into a computer, laptop, tablet, mobile device, or other computing device in the audio system 300. In other embodiments, the microphone(s) 304 may be a microphone coupled to the computing device 302 using a wireless or wired connection (e.g., via a Universal Serial Bus (“USB”) port, an HDMI port, a 3.5 mm jack, a lightning port, or other audio port). In some embodiments, the microphone(s) 304 may be a ceiling array microphone, or an audio input device attached to a ceiling of the environment. As an example, the microphone(s) 304 may include, but is not limited to, SHURE GLX-D, QLX-D, MXW, MXA310, MX690, MXA710, MXA910, MXA920, MXA901, MXA902, and the like.

In some embodiments, the at least one microphone 304 may be configured to capture or obtain audio activity data associated with the audio source, or sounds produced by the audio source, for the purpose of identifying a current (e.g., real-time) location of the audio source. For example, the at least one microphone 304 may include sound localization software or other algorithm or component configured to generate a localization of a sound detected by that microphone 304, and determine coordinates (also referred to herein as “localization coordinates”) that represent, or can be used to calculate, a current or real-time location of the detected sound and/or the audio source. In such cases, the at least one microphone 304 can be further configured to broadcast or send the localization coordinates to the audio source locator 318, for example, as audio activity data to be used for determining the current audio source location, as described herein. In other embodiments, the at least one microphone 304 can be configured to determine or identify its own location using other locating techniques (e.g., LiDAR, RADAR, infrared, ultrasonic signals, ultrawideband signals, video or other image capture, global positioning service (GPS), live location tracking, etc.), and may provide its location to the audio source locator 318, the sound reinforcement handler 316, and/or the computing device 302. In cases where the microphone 304 is portable (e.g., handheld or wireless) and thus, travels with the audio source about the room, the microphone location may be used as the current audio source location, or otherwise used to determine the current audio source location.

The one or more loudspeakers 306 may be any type of audio speaker, speaker system, or other audio output device configured to audibly play, or reproduce, audio signals generated by the at least one microphone 304 in order to provide appropriate audible reinforcement of the microphone signals in select areas of the environment (e.g., the audience area 101 in FIG. 1). More specifically, a sound reinforcement setting of each loudspeaker 306, such as, e.g., an acoustic gain setting or other setting for controlling an output volume, can be configured to provide appropriate amplification or reinforcement of the microphone signals for the listeners or audience members located in the select areas of the environment. Like the one or more loudspeaker(s) 106, the location of each loudspeaker 306 may be known or discovered prior to the start of the live event (e.g., during set up of the audio system 300), and the corresponding loudspeaker location information (e.g., location coordinates, relative distance measurements, etc.) may be stored in a memory of the loudspeaker 306 and/or the computing device 302 and provided to the sound reinforcement handler 316 for use in calculating appropriate sound reinforcement settings, as described herein.

In some embodiments, the loudspeaker(s) 306 may be a standalone network audio device that includes a speaker, a native speaker built into a computer, laptop, tablet, mobile device, or other computing device in the audio system 300. In other embodiments, the loudspeaker(s) 306 may be a loudspeaker coupled to the computing device 302 using a wireless or wired connection (e.g., via a Universal Serial Bus (“USB”) port, an HDMI port, a 3.5 mm jack, a lightning port, or other audio port). In some cases, the loudspeaker 306 includes a plurality of audio drivers arranged in an array (i.e., a speaker array). As an example, the loudspeaker(s) 306 may include, but are not limited to, SHURE MXN5C-W and the like.

Though not shown, the audio system 300 may further include one or more other loudspeakers that are configured to play far-end audio signals associated with the audio event, such as, sounds produced by far-end participants of a conferencing call or others not physically present in the room during an event. These other loudspeakers may be different from the at least one loudspeaker 306 configured to provide sound reinforcement during a live event.

The one or more audio source sensors 308 may be any type of sensor or sensing device capable of detecting and/or gathering audio activity information that indicates, or can be used to calculate, a current or real-time location of an audio source, like the audio source sensor(s) 108. The audio source sensor(s) 308 may be configured to obtain audio activity information (or data) that is associated with the audio source, the at least one microphone 304, the one or more loudspeakers 306, and/or any other component of the audio system 300. For example, in some embodiments, the audio source sensor(s) 308 may obtain audio activity data upon detecting audio, motion, and/or any other relevant activity of the audio source. In various embodiments, the audio activity data obtained by the sensor(s) 308 may include sound localization information (e.g., localization coordinates) associated with sounds produced by the audio source and detected by the sensor 308, location information indicating a position of the audio source (e.g., talker location) relative to the sensor 308 that detected the sounds, proximity or distance information (e.g., measurement of distance between the detected audio source and the detecting sensor 308); and/or any other relevant information. The audio source sensor(s) 308 may be in communication with the audio source locator 318, which can be configured to receive or aggregate audio activity data from the one or more audio source sensors 308 and/or other components of the audio system 300 and determine the current audio source location based thereon. In some embodiments, the one or more audio source sensors 308 may be further configured to determine the current location of the audio source based on the audio activity data obtained thereby, and may provide the current audio source location directly to the sound reinforcement handler 316. In such cases, the audio source locator may be, at least partially, included in each sensor 308 for determining the current audio source location, for example, as a cloud-based or distributed processing system.

As an example, the audio source sensor(s) 308 can include a motion sensor, image capturing device, or other non-audio sensing device or sensor (e.g., infrared sensor, ToF sensor, LiDAR sensor, laser, telemetry sensor, etc.) that is configured to obtain or determine location information, relative position information, proximity information, and/or other audio activity data, upon detecting movement of the audio source, based on distance measurements taken between the sensor 308 and the audio source, or using other techniques, as will be appreciated. As another example, the one or more audio source sensors 308 can include microphones (e.g., microphone array) or other audio capturing devices that comprise a sound localization component (e.g., software) configured to localize detected sounds and generate, based thereon, localization coordinates or other location data that identifies a relative location of the detected sound (e.g., relative to the sensor 308 that detected the sound, or another component of the audio system 300). In some embodiments, the audio source sensor(s) 308 may provide the localization coordinates to the audio source locator 318 as the current or real-time position of the audio source, or talker, that produced the sound. In other embodiments, the audio source locator 318 can be configured to triangulate or estimate the current audio source location based on localization coordinates and/or other audio activity data received from multiple audio source sensors 308.

In general, the audio source locator 318 can be configured to receive audio activity data from one or more other components of the audio system 300, such as, e.g., the one or more audio source sensors 308 and/or the at least one microphone 304, use the audio activity data to determine a current location of the audio source location, and provide the current audio source location to the sound reinforcement handler 316 for dynamic control or adjustment of appropriate sound reinforcement settings, as described herein. For example, the audio source locator 318 may receive localization coordinates and/or other sound localization information for a given audio signal, from the microphone 304 or sensor 308 that detected the underlying audio, and based thereon, may calculate or estimate the audio source location for that signal, or the location of the talker or other audio source that generated the audio.

In some cases, the audio source locator 318 may receive certain pieces of audio activity information from the microphone(s) 304 and/or the audio source sensor(s) 308 and may generate other pieces of audio activity information based thereon. For example, the audio source locator 318 may calculate or determine an audio quality score for the detected audio signal based on the sound localization information received from the microphone 304, in order to determine that the detected sound is in fact speech or vocals and thus, can be used to identify a current location of the underlying audio source. In other cases, the audio activity data received at the audio source locator 318 may include an audio quality score for each audio signal, information identifying the type of audio included in the audio signal (e.g., human speech or voice, noise, etc.), or any other information related to identifying whether the detected audio comprises voice activity or other desired sounds.

Accordingly, in various embodiments, the at least one microphone 304, the one or more audio source sensors 308, the audio source locator 318, and/or other component of the audio system 300 may include or use a voice activity detector (or “VAD”), such as, e.g., a cepstral voice activity detector, or use any other suitable detector or component to implement voice activity detection techniques, including the techniques described in co-owned U.S. patent application Ser. No. 18/397,693, the contents of which are incorporated by reference herein in their entirety. For example, the voice activity detector can analyze the structure of detected audio and use energy estimation techniques, zero-crossing count techniques, cepstrum techniques, machine-learning or artificial intelligence methods, cues from video associated with the event, or any other suitable techniques to identify or differentiate voice sounds (e.g., human speech) and noise sounds (e.g., non-voice audio), detect the presence or absence of human speech in a given audio signal, and/or to identify or differentiate far-end audio and near-end audio.

As shown, the audio source locator 318 may be housed or stored, at least partially, in the computing device 302 and may be in communication with other components of the audio system 300 via the computing device 302 (e.g., indirectly). In other embodiments, the audio source locator 318 may be a separate device (e.g., audio processing device) that is communicatively coupled to the computing device 302 and the other components of the audio system 300. In still other embodiments, all or a portion of the audio source locator 318 may be included in, or part of, the at least one microphone 304 and/or any of the one or more audio source sensors 308. In such cases, the audio source locator 318 may use the audio activity data obtained by the component in which it resides to calculate the current audio source location and may transmit or provide that location to the computing device 302. In one embodiment, the computing device 302 may be configured to aggregate or combine audio source location information generated by multiple components of the audio system 300 and based thereon, determine a best estimate for the current location of the audio source.

In general, the sound reinforcement handler 316 can be configured to automatically determine appropriate sound reinforcement settings for each sound reinforcement loudspeaker 306 based on a position of that loudspeaker 306 relative to a current location of the audio source, or otherwise control amplification of the microphone signals output by each loudspeaker 306 so that, as the audio source moves about a room, listeners throughout the room can hear the audio source equally or similarly well. As described herein, the sound reinforcement handler 316 may use information obtained or received from one or more other components of the audio system 300 to determine the relative positions of the audio source and/or each loudspeaker 306. For example, the sound reinforcement handler 316 may be in communication with the audio source locator 318 in order to receive real-time or near real-time location information associated with the audio source, or the current audio source location. In other embodiments, the sound reinforcement handler 316 may receive the current audio source location from the at least one microphone 304 and/or the audio source sensor(s) 308, either through direct communication with the component(s), or indirectly via the computing device 302. The sound reinforcement handler 316 may also receive loudspeaker location information from each loudspeaker 306, either directly or via the computing device 302. In some embodiments, the sound reinforcement handler 316 may receive the loudspeaker location information prior to the live event, or during set-up of the audio system 300 and/or the computing device 302, and may store the loudspeaker location information in a memory of the sound reinforcement handler 316, the memory 312 of the computing device 302, or any other suitable memory device.

As shown, the sound reinforcement handler 316 may be housed or stored, at least partially, in the computing device 302 and may be in communication with other components of the audio system 300 via the computing device 302 (e.g., indirectly). In other embodiments, the sound reinforcement handler 316 may be a separate device (e.g., processing device) that is communicatively coupled to the computing device 302 and the other components of the audio system 300. In still other embodiments, all or a portion of the sound reinforcement handler 316 may be included in, or part of, any of the one or more loudspeakers 306. In such cases, the sound reinforcement handler 316 may use the location of the corresponding loudspeaker 306 to determine a distance to the current audio source location and may calculate an appropriate value for the sound reinforcement setting of that loudspeaker 306 based on said distance.

As described with respect to the computing devices 102 and 202 in FIGS. 1 and 2, the sound reinforcement handler 316 can be configured to dynamically apply subtle changes to the acoustic gain or other sound reinforcement setting of each loudspeaker 306 as an audio source moves about a room and/or relative to the loudspeaker(s) 306 during a live performance or other event. According to various embodiments, each time the sound reinforcement handler 316 receives audio source location information from the audio source locator 318, or other component of the audio system 300, the sound reinforcement handler 316 may first compare the newly-received audio source location to previously-received audio source location information to determine whether the audio source has moved from its previous location. If the sound reinforcement handler 316 determines that the two locations are the same or very close together (e.g., separated by a distance that is equal to or less than a threshold value), the sound reinforcement handler 316 may keep the values for the sound reinforcement settings of the loudspeaker(s) 306 unchanged (i.e. make no new calculations). On the other hand, if the new audio source location is sufficiently far from the previous location (e.g., separated by a distance that exceeds a threshold value), the sound reinforcement handler 316 may calculate the new sound reinforcement values based on the new audio source location, and the known loudspeaker locations, for example, using process 400 shown in FIG. 4 and described below.

Any of the sound localization algorithms or components described herein may use any method for generating sound localizations, including, for example, generalized cross-correlation (“GCC”), phase-transformed GCC (“PHAT-GCC”), MUSIC, MVDR, super resolution techniques such as ESPRIT, and/or others. According to various embodiments, the localization coordinates may be Cartesian or rectangular coordinates that represent a location point in three dimensions, or x, y, and z values. In some cases, the localization coordinates may be converted to polar or spherical coordinates, i.e. azimuth (phi), elevation (theta), and radius (r), for example, using a transformation formula, as is known in the art. In other embodiments, the localization coordinates may be converted to a common coordinate system (e.g., global or universal coordinate system, a room-specific or other local coordinate system, etc.) that is used throughout the audio system 300 and/or environment for ease of communication between components and calculation of distance measurements and the like. The localization coordinates received from the audio source locator 318 may be relative to, or part of a coordinate system of, the one or more audio source sensors 308, the at least one microphone 304, the environment in which the audio system 300 is located, or another component of the audio system 300.

FIG. 4 illustrates an exemplary method or process 400 for providing dynamic sound reinforcement of an audio source (e.g., audio source 105 of FIG. 1) for one or more listeners in an environment (e.g., environment 100 of FIG. 1) having at least one microphone (e.g., microphone 304 of FIG. 3) configured to convert sounds produced by the audio source into audio signals and one or more loudspeakers (e.g., sound reinforcement loudspeaker 306 of FIG. 3) configured to play the audio signals, in accordance with embodiments. The at least one microphone and the one or more loudspeakers may be collectively referred to herein as “audio devices,” and may be part of an audio system (e.g., audio system 300 of FIG. 3). All or portions of the process 400 may be performed by or using any of one or more processors (e.g., processor(s) 310 of FIG. 3) and/or other processing devices (e.g., analog to digital converters, encryption chips, etc.) that are within or external to the audio system, including, for example, one or more processors in communication with the at least one microphone and the one or more loudspeakers. In addition, one or more other types of components (e.g., memory, input and/or output devices, transmitters, receivers, buffers, drivers, discrete components, logic circuits, etc.) may also be used in conjunction with the one or more processors and/or other processing components to perform any, some, or all of the steps of the process 400. For example, the process 400 may be carried out by a computing device (e.g., computing device 302 of FIG. 3), or more specifically, one or more processors of said computing device (e.g., processor(s) 310 of FIG. 3) executing software stored in a memory (e.g., memory 312 of FIG. 3), such as, e.g., sound reinforcement handler 316 and/or audio source locator 318 of the audio system 300, as shown in FIG. 3. In addition, the computing device may further carry out the operations of process 400 by interacting or interfacing with one or more other devices that are internal or external to the audio system and communicatively coupled to the computing device (e.g., microphone(s) 304, loudspeaker(s) 306, audio source sensor(s) 308, or other component associated with the audio system 300 of FIG. 3).

As shown in FIG. 4, in some embodiments, the process 400 may comprise, at step 402, obtaining a first loudspeaker location (or “speaker location”) associated with a first sound reinforcement loudspeaker (e.g., first loudspeaker 106a of FIG. 1) from at least one memory (or memory device) in communication with any of the one or more processors. The loudspeaker location may include location coordinates, distance measurements, or any other information that identifies a position of the first loudspeaker within the environment. In some embodiments, loudspeaker location information for each of the loudspeakers in the audio system may be previously stored in the at least one memory, for example, before the live event begins or during a set-up procedure for the audio system, and may be retrieved from the at least one memory once the sound reinforcement feature is turned on or activated.

The process 400 may further comprise, at step 404, obtaining a first audio source location for an audio source detected by the at least one microphone. In some embodiments, step 404 includes determining the first audio source location based on first audio activity data associated with the audio source, or sounds generated thereby, and obtained or gathered by one or more audio source sensors (e.g., the one or more audio source sensors 308 of FIG. 3), and/or other components of the audio system, such as, for example, the at least one microphone, the one or more loudspeakers, etc. The audio source sensor(s) may be included in the audio system and may be in communication with the one or more processors, which may use an audio source locating component (e.g., audio source locator 318 of FIG. 3) or other software stored in the memory to determine or calculate the current audio source location based on received audio activity data.

The audio source sensor(s) may include non-audio sensors (e.g., infrared sensor, motion sensor, laser, LiDAR sensor, etc.), audio sensors (e.g., microphone or microphone array), or any other sensing device capable of detecting audio, motion, or other activity of the audio source. The audio activity data or information provided by the one or more audio source sensors may be any type of information that is associated with the audio source, or sounds produced by the audio source, and is suitable for estimating the current (e.g., real-time or near real-time) location of the audio source, including, for example, sound localization coordinates, distance or proximity information, relative position information, and/or other location information, as described herein.

As described herein, the first loudspeaker may be configured to provide sound reinforcement of microphone signals, or audio signals generated by the at least one microphone upon capturing sounds produced by an audio source during a live event, so that listeners located further away from the audio source can hear the performance or speech of the audio source as clearly and loudly as the listeners located close by. The amount of reinforcement, or amplification, needed to maintain an even or consistent audio level throughout the environment can vary depending on how far the audio source is from the loudspeaker.

Accordingly, step 406 of the process 400 comprises calculating a first distance (e.g., d1 of FIG. 1) between the first speaker location associated with the first loudspeaker (e.g., obtained at step 402) and the first audio source location associated with the audio source (e.g., obtained at step 404), and step 408 comprises determining, based on the first distance, a first value for a sound reinforcement setting of the first loudspeaker. The sound reinforcement setting may include an acoustic gain setting of the first loudspeaker, or any other setting that controls an output volume or amplification of the microphone signals playing on the loudspeaker. In various embodiments, step 408 may include using Equation 1 provided above to calculate the first reinforcement gain value, or other similar techniques, as described herein. In some embodiments, step 408 further comprises configuring the first loudspeaker according to the first value, or otherwise applying the first value to the sound reinforcement setting of the first loudspeaker.

As also described herein, in various embodiments, the at least one microphone may be a wireless microphone, handheld microphone, or other portable microphone that can be carried by or with the audio source while performing or presenting during the live event, for example. When the audio source moves to a new location, specifically relative to the first loudspeaker and any other sound reinforcement loudspeaker in the room, the amount of sound reinforcement required at each loudspeaker location may change (e.g., increase or decrease) depending on whether the audio source has traveled closer or further away from that loudspeaker. Accordingly, the process 400 is configured to dynamically adjust the sound reinforcement setting (or output gain) of the first loudspeaker as the audio source moves about the event space, so that the microphone signals are audible at the same level throughout the space.

In particular, step 410 comprises obtaining a second audio source location for the audio source that is different from the first audio source location. In some embodiments, step 410 further comprises determining the second audio source location based on second audio activity data obtained or gathered by the one or more audio source sensors and/or other components of the audio system (e.g., the at least one microphone, the one or more loudspeakers, etc.). The second audio activity data may be associated with the audio source, or sounds generated thereby, and may be received after the audio source moves away from the first audio source location. Accordingly, in some cases, step 410 further comprises comparing the second audio activity data to the first audio activity data to determine whether the audio source has moved or changed locations, and upon determining that the two data sets are sufficiently different, determining or calculating the second audio source location based on the second audio activity data. In other cases, step 410 may include comparing the second audio source location to the first audio source location to determine whether the two locations are sufficiently different (e.g., separated by a threshold distance) and if they are, continuing to step 412 of the process 400.

As shown in FIG. 4, step 412 comprises calculating a second distance (e.g., d2 in FIG. 1) between the first speaker location and the second audio source location associated with the audio source. And step 414 comprises determining, based on the second distance, a second value for the sound reinforcement setting of the first loudspeaker. The one or more processors may be configured to calculate the second value using the same formula or technique used in step 408 to calculate the first value. Accordingly, in various embodiments, step 414 can further comprise, if the second distance is greater than the first distance, calculating a number or amount for the second sound reinforcement value that is higher than the first sound reinforcement value. Likewise, step 414 can further comprise, if the second distance is smaller than the first distance, calculating a number or amount for the second sound reinforcement value that is lower than the first sound reinforcement value.

In some embodiments, the process 400 is further configured to avoid feedback or other undesirable audio effects that may occur if the sound reinforcement effects are provided to listeners located near or close to the audio source. Accordingly, step 414 further comprises comparing the second distance to a threshold distance, or distance value, that is stored in a memory of the audio system, and upon determining that the second distance equals or exceeds the threshold distance, calculating a number or amount greater than zero for the second sound reinforcement value. In addition, step 414 comprises, upon determining that the second distance is less than the threshold distance, setting the second sound reinforcement value to zero, or otherwise turning off the sound reinforcement setting of the first loudspeaker. As an example, the threshold distance may be about eight feet, less than 10 feet, or any other distance value appropriate for the loudspeaker, the at least one microphone, and/or the environment as a whole.

As shown in FIG. 4, from step 414, the process 400 moves to step 416, which comprises adjusting the sound reinforcement setting of the first loudspeaker from the first value to the second value. In this manner, the process 400 can be configured to apply appropriate changes to the sound reinforcement effect provided by the first loudspeaker as the audio source (or talker) moves about the environment during a live event.

In some embodiments, the process 400 further comprises applying similar techniques or steps to adjust the sound reinforcement settings of any other loudspeakers located in the same environment. For example, the process 400 may further comprise calculating a third distance (e.g., d3 in FIG. 1) between the first audio source location and a second speaker location associated with a second loudspeaker (e.g., fourth loudspeaker 106d in FIG. 1) in communication with any of the one or more processors, and determining, based on the third distance, a third value for a sound reinforcement setting of the second loudspeaker. In such cases, the process 400 may also comprise calculating a fourth distance (e.g., d4 in FIG. 1) between the second audio source location and the second speaker location, and determining, based on the fourth distance, a fourth value for the sound reinforcement setting of the second loudspeaker. In addition, the process 400 may comprise adjusting the sound reinforcement setting of the second loudspeaker from the third value to the fourth value. The fourth sound reinforcement value may be less than or higher than the first sound reinforcement value depending on whether the audio source has moved closer or further away. In embodiments, the process 400 may end once sound reinforcement settings for all relevant loudspeakers in the environment have been appropriately adjusted, as needed.

Referring back to FIG. 3, any of the processors described herein, such as, e.g., the one or more processors 310, may include a general purpose processor (e.g., a microprocessor) and/or a special purpose processor (e.g., an audio processor, a digital signal processor, etc.). In some examples, processor 310, and/or any other processor described herein, may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs).

Any of the memories or memory devices described herein, such as, e.g., memory 312, may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 312, and/or any other memory described herein, includes multiple kinds of memory, particularly volatile memory and non-volatile memory.

Moreover, any of the memories described herein (e.g., memory 312) may be computer readable media on which one or more sets of instructions, such as the software for operating the techniques described herein, can be embedded. The instructions may reside completely, or at least partially, within any one or more of the memory, the computer readable medium, and/or within one or more processors (e.g., processor(s) 310) during execution of the instructions. In some embodiments, memory 312, and/or any other memory described herein, may include one or more data storage devices configured for implementation of a persistent storage for data that needs to be stored and recalled by the end user, such as, e.g., location data received from one or more microphones, audio source sensors, loudspeakers, or other components, prestored location data or coordinates indicating a known location of one or more loudspeakers, and more. In such cases, the data storage device(s) may save data in flash memory or other memory devices. In some embodiments, the data storage device(s) can be implemented using, for example, SQLite data base, UnQLite, Berkeley DB, BangDB, or the like.

In some embodiments, any of the computing devices described herein, such as, e.g., the computing device 302, may include one or more components configured to facilitate a conference call, meeting, class, presentation, performance, or other live event, and/or process audio signals associated therewith to improve an audio quality of the event. For example, in various embodiments, the computing device 302, and/or any other computing device described herein, may comprise a digital signal processor (“DSP”) configured to process the audio signals received from the various audio sources using, for example, automatic mixing, matrix mixing, delay, compressor, parametric equalizer (“PEQ”) functionalities, acoustic echo cancellation, and more. In other embodiments, the DSP may be a standalone device operatively coupled or connected to the computing device using a wired or wireless connection. One exemplary embodiment of the DSP, when implemented in hardware, is the P300 IntelliMix Audio Conferencing Processor from SHURE, the user manual for which is incorporated by reference in its entirety herein. As further explained in the P300 manual, this audio conferencing processor includes algorithms optimized for audio/video conferencing applications and for providing a high quality audio experience, including eight channels of acoustic echo cancellation, noise reduction and automatic gain control. Another exemplary embodiment of the DSP, when implemented in software, is the IntelliMix Room from SHURE, the user guide for which is incorporated by reference in its entirety herein. As further explained in the IntelliMix Room user guide, this DSP software is configured to optimize the performance of networked microphones with audio and video conferencing software and is designed to run on the same computer as the conferencing software. In other embodiments, other types of audio processors, digital signal processors, and/or DSP software components may be used to carry out one or more of audio processing techniques described herein, as will be appreciated.

Various components of the computing device 302, and/or any other computing device described herein, may be implemented in hardware (e.g., discrete logic circuits, application specific integrated circuits (ASIC), programmable gate arrays (PGA), field programmable gate arrays (FPGA), etc.), using software (e.g., program modules comprising software instructions executable by a processor), or through a combination of both. For example, some or all components of the computing device 302, and/or any other computing device described herein, may use discrete circuitry devices and/or use a processor (e.g., audio processor, digital signal processor, or other processor) executing program code stored in a memory, the program code being configured to carry out one or more processes or operations described herein. In embodiments, all or portions of the processes may be performed by one or more processors and/or other processing devices (e.g., analog to digital converters, encryption chips, etc.) within or external to the computing device 302. In addition, one or more other types of components (e.g., memory, input and/or output devices, transmitters, receivers, buffers, drivers, discrete components, logic circuits, etc.) may also be utilized in conjunction with the processors and/or other processing components to perform any, some, or all of the operations described herein. For example, in FIG. 3, program code stored in the memory 312 of the computing device 302 may be executed by the processor 310 of the computing device 302, by a separate digital signal processor coupled to or included in the computing device 302, or by a separate audio processor in order to carry out one or more of the operations described herein. In some embodiments, the program code may be a computer program stored on a non-transitory computer readable medium that is executable by a processor of the relevant device.

Moreover, the computing device 302, and/or any of the other computing devices described herein, may also comprise various other software modules or applications (not shown) configured to facilitate and/or control the audio event, such as, for example, internal or proprietary conferencing software and/or third-party conferencing software (e.g., Microsoft Skype, Microsoft Teams, Bluejeans, Cisco Webex, GoToMeeting, Zoom, Join.me, etc.). Such software applications may be stored in the memory (e.g., memory 312) of the computing device and/or may be stored on a remote server (e.g., on premises or as part of a cloud computing network) and accessed by the computing device via a network connection. Some software applications may be configured as a distributed cloud-based software with one or more portions of the application residing in the computing device (e.g., computing device 302) and one or more other portions residing in a cloud computing network. One or more of the software applications may reside in an external network, such as a cloud computing network. In some embodiments, access to one or more of the software applications may be via a web-portal architecture, or otherwise provided as Software as a Service (SaaS).

It should be understood that examples disclosed herein may refer to computing devices and/or systems having components that may or may not be physically located in proximity to each other. Certain embodiments may take the form of cloud based systems or devices, and the term “computing device” should be understood to include distributed systems and devices (such as those based on the cloud), as well as software, firmware, and other components configured to carry out one or more of the functions described herein. Further, as noted above, one or more features of the computing device may be physically remote (e.g., a standalone microphone) and may be communicatively coupled to the computing device.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

Any process descriptions or blocks in the figures, such as, e.g., FIG. 4, should be understood as representing modules, segments, or portions of code that include one or more executable instructions for implementing specific logical functions or steps in the process, and alternate implementations are included within the scope of the embodiments described herein, in which functions may be executed out of order from that shown or discussed, including substantially concurrently or in reverse order, depending on the functionality involved, as would be understood by those having ordinary skill in the art.

Further, it should be noted that in the description and drawings, like or substantially similar elements may be labeled with the same reference numerals. However, sometimes these elements may be labeled with differing numbers, such as, for example, in cases where such labeling facilitates a more clear description. In addition, system components can be variously arranged, as is known in the art. Also, the drawings set forth herein are not necessarily drawn to scale, and in some instances, proportions may be exaggerated to more clearly depict certain features and/or related elements may be omitted to emphasize and clearly illustrate the novel features described herein. Such labeling and drawing practices do not necessarily implicate an underlying substantive purpose. The above description is intended to be taken as a whole and interpreted in accordance with the principles taught herein and understood to one of ordinary skill in the art.

In this disclosure, the use of the disjunctive is intended to include the conjunctive. The use of definite or indefinite articles is not intended to indicate cardinality. In particular, a reference to “the” object or “a” and “an” object is intended to also denote one of a possible plurality of such objects.

Moreover, this disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, which may be amended during the pendency of the application for patent, and all equivalents thereof, when interpreted in accordance with the breadth to which they are fairly, legally and equitably entitled.

What is claimed is:

1. A method of providing dynamic sound reinforcement of an audio source for one or more listeners in an environment using one or more processors in communication with at least one microphone and a first loudspeaker, the microphone configured to convert sounds produced by the audio source into audio signals, and the first loudspeaker configured to play the audio signals, the method comprising, using any of the one or more processors:
calculating a first distance between a first speaker location associated with the first loudspeaker and a first audio source location associated with the audio source;
determining, based on the first distance, a first value for a sound reinforcement setting of the first loudspeaker;
calculating a second distance between the first speaker location and a second audio source location associated with the audio source, the second audio source location different from the first audio source location;
determining, based on the second distance, a second value for the sound reinforcement setting of the first loudspeaker; and
adjusting the sound reinforcement setting of the first loudspeaker from the first value to the second value.

2. The method of claim 1, wherein determining a second value for the sound reinforcement setting comprises: if the second distance is greater than the first distance, calculating an amount for the second value that is higher than the first value.

3. The method of claim 1, wherein determining a second value for the sound reinforcement setting comprises: if the second distance is smaller than the first distance, calculating an amount for the second value that is lower than the first value.

4. The method of claim 1, wherein determining a second value for the sound reinforcement setting comprises:
comparing the second distance to a threshold distance;
upon determining that the second distance equals or exceeds the threshold distance, calculating an amount greater than zero for the second value; and
upon determining that the second distance is less than the threshold distance, setting the second value to zero.

5. The method of claim 1, wherein the sound reinforcement setting comprises an acoustic gain setting of the first loudspeaker.

6. The method of claim 1, wherein the at least one microphone is a wireless microphone.

7. The method of claim 1, further comprising obtaining the first speaker location from at least one memory in communication with any of the one or more processors.

8. The method of claim 1, wherein any of the one or more processors is further in communication with a second loudspeaker, the method further comprising:
calculating a third distance between the first audio source location and a second speaker location associated with the second loudspeaker;
determining, based on the third distance, a third value for a sound reinforcement setting of the second loudspeaker;
calculating a fourth distance between the second audio source location and the second speaker location;
determining, based on the fourth distance, a fourth value for the sound reinforcement setting of the second loudspeaker; and
adjusting the sound reinforcement setting of the second loudspeaker from the third value to the fourth value.

9. The method of claim 1, wherein any of the one or more processors is further in communication with one or more audio source sensors configured to obtain audio activity data associated with the audio source, the method further comprising:
determining the first audio source location based on first audio activity data obtained by the one or more audio source sensors; and
determining the second audio source location based on second audio activity data obtained by the one or more audio source sensors after the audio source moves from the first audio source location.

10. An audio system located in an environment, the audio system comprising:
at least one microphone configured to: capture sounds produced by an audio source located in the environment, and convert the sounds to audio signals;
a first loudspeaker configured provide sound reinforcement of the audio source for one or more listeners in the environment by playing the audio signals, the first loudspeaker positioned at a first speaker location; and
one or more processors in communication with the at least one microphone and the first loudspeaker, any of the one or more processors configured to:
calculate a first distance between the first speaker location and a first audio source location associated with the audio source;
determine, based on the first distance, a first value for a sound reinforcement setting of the first loudspeaker;
calculate a second distance between the first speaker location and a second audio source location associated with the audio source, the second audio source location different from the first audio source location;
determine, based on the second distance, a second value for the sound reinforcement setting of the first loudspeaker; and
adjust the sound reinforcement setting of the first loudspeaker from the first value to the second value.

11. The audio system of claim 10, further comprising a second loudspeaker positioned at a second speaker location and in communication with the one or more processors, wherein any of the one or more processors is further configured to:
calculate a third distance between the first audio source location and a second speaker location associated with the second loudspeaker;
determine, based on the third distance, a third value for a sound reinforcement setting of the second loudspeaker;
calculate a fourth distance between the second audio source location and the second speaker location;
determine, based on the fourth distance, a fourth value for the sound reinforcement setting of the second loudspeaker; and
adjust the sound reinforcement setting of the second loudspeaker from the third value to the fourth value.

12. The audio system of claim 10, further comprising: one or more audio source sensors in communication with the one or more processors and configured to obtain audio activity data associated with the audio source, wherein any of the one or more processors is further configured to:
determine the first audio source location based on first audio activity data obtained by the one or more audio source sensors; and
determine the second audio source location based on second audio activity data obtained by the one or more audio source sensors after the audio source moves away from the first audio source location.

13. The audio system of claim 12, wherein the one or more audio source sensors comprises a microphone.

14. The audio system of claim 12, wherein the one or more audio source sensors comprises a non-audio sensor.

15. The audio system of claim 10, wherein determining a second value for the sound reinforcement setting comprises: if the second distance is greater than the first distance, calculating an amount for the second value that is higher than the first value.

16. The audio system of claim 10, wherein determining a second value for the sound reinforcement setting comprises: if the second distance is smaller than the first distance, calculating an amount for the second value that is lower than the first value.

17. The audio system of claim 10, wherein determining a second value for the sound reinforcement setting comprises:
comparing the second distance to a threshold distance;
upon determining that the second distance equals or exceeds the threshold distance, calculating an amount greater than zero for the second value; and
upon determining that the second distance is less than the threshold distance, setting the second value to zero.

18. The audio system of claim 10, wherein the sound reinforcement setting comprises an acoustic gain setting of the first loudspeaker.

19. The audio system of claim 10, wherein the at least one microphone is a wireless microphone.

20. A non-transitory computer-readable storage medium comprising instructions that, when executed by one or more processors, cause any of the one or more processors to perform operations comprising:
calculating a first distance between a first speaker location associated with the first loudspeaker and a first audio source location associated with the audio source;
determining, based on the first distance, a first value for a sound reinforcement setting of the first loudspeaker;
calculating a second distance between the first speaker location and a second audio source location associated with the audio source, the second audio source location different from the first audio source location;
determining, based on the second distance, a second value for the sound reinforcement setting of the first loudspeaker; and
adjusting the sound reinforcement setting of the first loudspeaker from the first value to the second value.
